(19) United States
(12) Patent Application Publication
(10) Pub. No.: US 2026/0232512 A1
(43) Pub. Date: Aug. 13, 2026

(54) KNEE RANGE OF MOTION (ROM) ORTHOPAEDIC BOARD APPARATUS AND METHOD

(71) Applicant: DLORTHOVENTURES LLC, Mount Pleasant, SC (US)

(72) Inventor: Dustin Hambright, Mount Pleasant, SC (US)

(73) Assignee: DLORTHOVENTURES LLC, Mount Pleasant, SC (US)

(21) Appl. No.: 19/052,489

(22) Filed: Feb. 13, 2025

(51) Int. Cl. A61H 1/02

(52) U.S. Cl. CPC A61H 1/024; A61H 2203/0437

(57) ABSTRACT

An apparatus to assist in range of motion (ROM) exercises, comprising a ROM board configured to lay on the ground or floor, the board dimensioned to receive a chair, the board having a plurality of both indents or indentations and undulating elevated foot stops of varying heights. The ROM board has generally a rectangular shape with a pair of lateral chair stop extensions extending from each side of the ROM board. The ROM board has a portion starting from a first end of the ROM board being a planar surface with a plurality of lateral indents or indentations and a portion having thereon a plurality of undulating elevated foot stops at the terminal end of the ROM board.

### CROSS REFERENCE TO RELATED APPLICATION

Not Applicable.

### TECHNICAL FIELD

The invention relates to a method and apparatus that facilitate the recovery from knee replacement and/or repair surgery.

### BACKGROUND

A total knee arthroplasty (TKA), commonly known as a total knee replacement, is a surgical procedure in which a damaged or worn-out knee joint is replaced with an artificial implant. It is typically performed to relieve pain and restore function in individuals with severe knee arthritis, most commonly osteoarthritis, but also rheumatoid arthritis or post-traumatic arthritis.

A TKA involves the surgeon making an incision over the knee to expose the joint. The damaged cartilage and a small portion of underlying bone from the femur (thigh bone), tibia (shin bone), and sometimes the patella (kneecap) are removed. Metal and plastic prosthetic components are positioned to replace the removed joint surfaces. The artificial knee is tested for proper movement, alignment, and function. The incision is closed, and rehabilitation begins soon after surgery to restore mobility.

There are several types of knee replacements: These include a TKA where the entire knee joint is replaced. In a partial knee replacement only one part of the knee is replaced if damage is limited. In a revision knee replacement, a second surgery in undertaken to replace a worn-out or failed implant.

After a TKA, physical therapy begins immediately post-surgery. A full recovery typically takes 3-6 months, with significant improvement in pain and function. Rehabilitation is crucial for a successful recovery after a TKA. Exercises focus on reducing stiffness, improving range of motion, strengthening muscles, and restoring function. Products for home therapy for knee ROM that do not have the advantages of the invention include straps that hook onto the foot allowing a patient to progressively pull the knee back, postoperative seated bikes used for range of motion, and sliding plastic plates that allow a patient to slide a foot back and forth on a floor to help with range of motion.

What is desired is a method and apparatus that assists in regaining full knee function and assists in the patient returning to normal activities.

### SUMMARY

The invention is an orthopaedic range of motion (ROM) board (“ROM Board”) configured to be positioned on a floor under a chair. The ROM Board is structured to allow one or more legs of a chair to be positioned proximate thereto. The patient sits in the chair and rotates their knee through a range of motions by placing their foot corresponding to the knee being rehabilitated against one of a plurality of undulating elevated foot stops which are located in front of the patient on the ROM Board or in one of the plurality of indents on the ROM Board that are located under and behind the chair.

The ROM Board is generally a rectangular shape with a pair of lateral chair stop extensions extending from each side of the ROM Board. The ROM Board has a first portion starting from a first back edge (or end) of the ROM Board, the first portion being a planar surface with a plurality of lateral indents or indentations, the first portion starting at the edge of the ROM Board extending about 2/6 of the length of the ROM Board, a second portion that extends from the first portion for about ⅙ of the length of the ROM Board and includes a pair of chair stops that extend laterally from each side of the ROM Board, a third portion that extends from the second portion about ⅙ of the length of the ROM Board and comprises a flat planar surface and a fourth portion extending from the third portion about ⅓ of the length of the ROM Board to the terminal edge of the ROM Board there being a plurality of undulating elevated foot stops on the fourth portion thereof, such undulating elevated foot stops becoming progressively taller from the proximate end of the fourth portion to the terminal end thereof. The use of the term “portion” is just to indicate the relative positions of the different features and characteristics of the ROM Board as the ROM Board is an integrated unit or can be made of components that fit together to form an integrated unit.

The chair is positioned over the ROM Board and can be positioned proximate or secured to the ROM Board while the patient is using the invention. The invention is comprised of a hard plastic base with a plurality of lateral indentions on a first portion thereof and a plurality of undulating elevated foot stops on the fourth portion thereof. The undulating elevated foot stops comprise a first proximal undulating elevated foot stop nearest the chair, to one or more middle undulating elevated foot stops to a terminal undulating elevated foot stop furthest from the chair. According to the method of the invention, the patient sits in the chair, places their leg or foot corresponding to the knee being rehabilitated atop the most distal elevated foot step in full extension and then places their foot against one of the undulating elevated foot stops or places their feet under the chair into one of the plurality of indents depending on the amount of knee flexion that is desired.

Starting with the terminal undulating elevated foot stop and then repositioning to the proximal undulating elevated foot stop, the patient can progressively flex the knee from an extended position of approximately 0 degrees extension to 45 degrees of flexion to 90 degrees of flexion. The ROM Board then has progress indents under and behind the chair for foot locking as the patient flexes their knees from beyond 90 degrees to past 120 degrees of flexion.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the invention including the features, advantages and specific embodiments, reference is made to the following detailed description along with accompanying Figures, wherein:

FIG. 1 is a perspective view of the invention without a chair positioned proximate therein;

FIG. 2 is a perspective view of the invention with a chair positioned proximate to the invention;

FIG. 3 is a top view of the invention;

FIG. 4 is side view of the invention;

FIG. 5 is view of a patient in the invention showing a positioning of the knees at a 45 degree angle of flexion; and

FIG. 6 is a flow chart of the method of the invention.

### DETAILED DESCRIPTION

While the making and using of the disclosed embodiments of the invention is discussed in detail below, it should be appreciated that the invention provides many applicable inventive concepts which can be embodied in a wide variety of specific contexts. Some features of the preferred embodiments shown and discussed may be simplified or exaggerated for illustrating the principles of the invention.

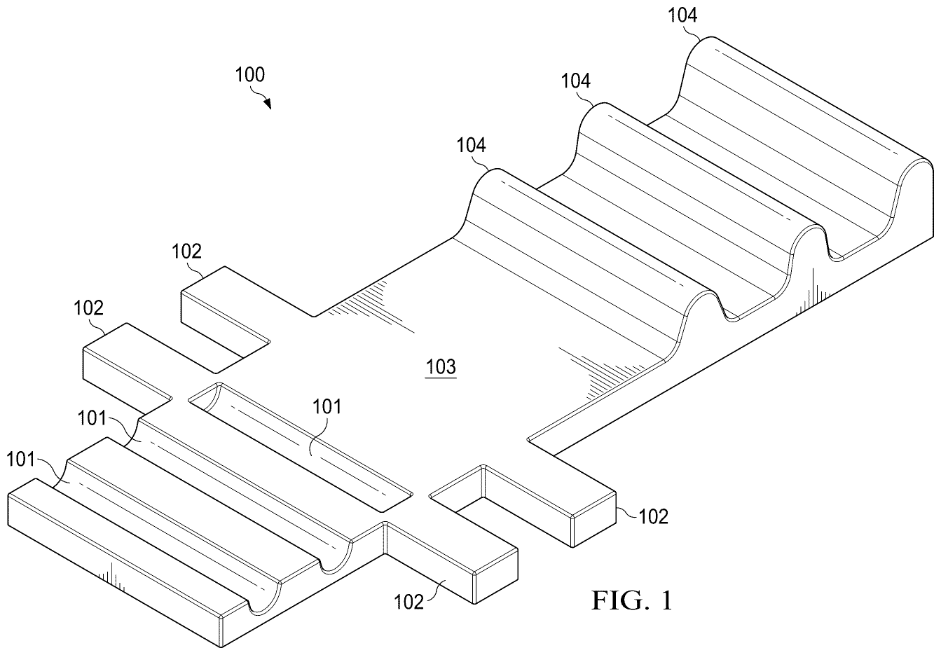

Referring now to FIG. 1, there is seen a perspective view of the invention without a chair positioned therein. The ROM Board 100 is generally a rectangular shape with a pair of lateral chair stop extensions 102 extending from each side of the ROM Board 100. The ROM Board 100 has a first portion starting from a first back edge or end of the ROM Board 100, the first portion being a planar surface with a plurality of lateral indents or indentations 101, the first portion starting at the edge of the ROM Board 100 extending about 2/6 of the length of the ROM Board 100, a second portion that extends from the end of the first portion for about ⅙ of the length of the ROM Board 100 and includes a pair of chair stops 102 that extend out laterally from each side of the ROM Board 100, a third portion that extends from the end of the second portion about ⅙ of the length of the ROM Board 100 and comprises a flat planar surface 103 and a fourth portion extending from the end of the third portion about ⅓ of the length of the ROM Board 100 to the terminal end of the ROM Board 100 there being a plurality of undulating elevated foot stops 104 on the fourth portion thereof, such undulating elevated foot stops 104 becoming progressively taller from the proximate end to the terminal end of the fourth portion and running laterally across the surface of the ROM Board 100. In one embodiment of the ROM Board 100 there are 3 lateral indents or indentations 101 and 3 undulating elevated foot stops 104. In an embodiment, the indentations have a concavity with a radius and the undulating elevated foot stops can be a convex structure having a radius. The relative lengths of each portion of the ROM Board 100 with respect to the entire ROM Board are general approximations are do not constrain the relative sizes of the invention or the portions thereof. In an embodiment, the ROM Board can have an overall length of between 30 inches and 60 inches and width of between 10 inches and 30 inches, with each portion being a subset of such overall length but having the same width. In an embodiment, the depth of each indent or indentation 101 at the extent thereof is between . 25 inches and 3 inches and the height of each undulating elevated foot stop 104 is between 1 inch and 7 inches. The invention is described as being dimensioned to receive one or more legs of a chair but any type of sitting device such as a stool can be used with the invention and the use of the term “chair” includes its use with any sitting device. Further, the invention comprises the ROM Board alone, or in combination with a chair. Further, an embodiment of the ROM Board can have only undulating elevated foot stops or only indents or indentations and can be dimensioned as necessary to accommodate only such features.

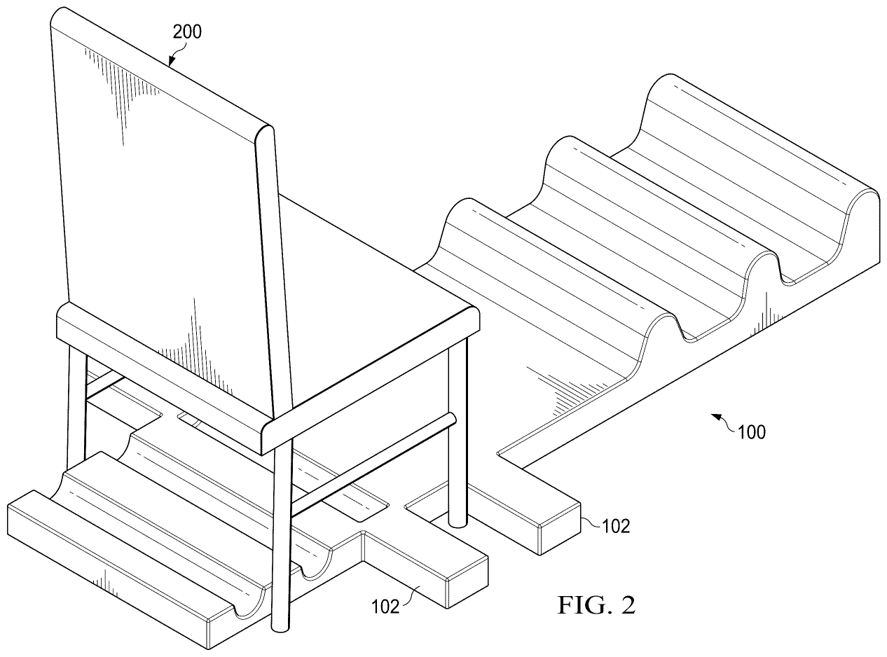

Referring now to FIG. 2, there is seen a perspective view of the invention with a chair 200 positioned within the chair stops 102 that extend out laterally from the ROM Board 100, the chair 200 positioned proximate to the ROM Board.

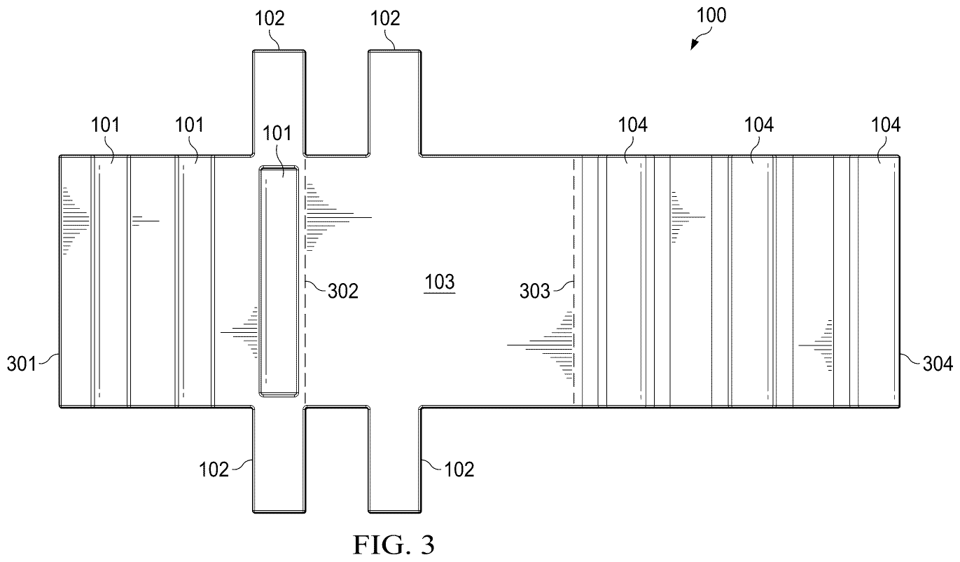

Referring now to FIG. 3, there is seen is a top view of the invention of the ROM Board 100. As seen therein, the ROM Board 100 has a first portion starting from a first back end or edge 301 of the ROM Board 100, the first portion being a planar surface with a plurality of indents 101, the first portion starting at the edge of the ROM Board 100 extending about 2/6 of the length of the ROM Board 100, a second portion that extends from 302 the first portion for about ⅙ of the length of the ROM Board 100 and includes chair stops 102 that extend laterally from the ROM Board 100, a third portion that extends from 303 the second portion about ⅙ of the length of the ROM Board 100 and comprises a flat planar surface 103 and a fourth portion extending from the third portion about ⅓ of the length of the ROM Board 100 to the terminal edge or end 304 of the ROM Board 100, there being a plurality of undulating elevated foot stops 104 on the fourth portion thereof running laterally across the surface of the ROM Board 100, such undulating elevated foot stops 104 becoming progressively taller or having a greater height from the proximate end to the terminal edge or end of the fourth portion. In one embodiment of the ROM Board 100 there are 3 lateral indents or indentations 101 and 3 undulating elevated foot stops 104. In an embodiment, the indentations have a concavity with a radius and the undulating elevated foot stops can be a convex structure having a radius. The relative lengths of each portion of the ROM Board 100 with respect to the entire ROM Board are general approximations and are not meant to, and do not constrain the size of the invention or the respective portions thereof. In an embodiment, the ROM Board can have an overall length of between 30 inches and 60 inches and width of between 10 inches and 30 inches, with each portion being a subset of such overall length but each portion having the same overall width of the ROM Board. In an embodiment, the depth of each indent or indentation 101 at the extent thereof is between 0.25 inches and 3 inches and the height of each undulating elevated foot stop 104 is between 1 inch and 7 inches.

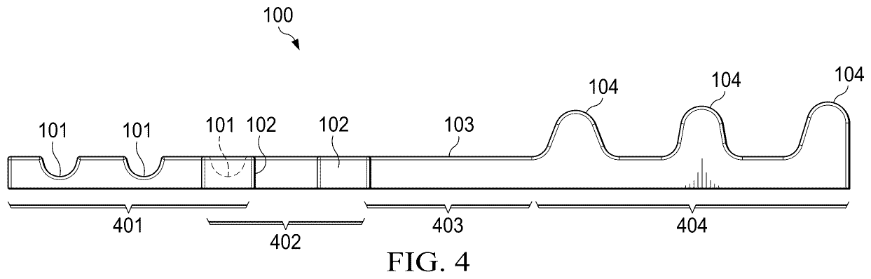

Referring now to FIG. 4, there is seen a side view of the invention. As seen therein, the ROM Board 100 has a first portion 401 starting from a first end of the ROM Board 100, the first portion 401 being a planar surface with a plurality of lateral indents or indentations 101, the first portion 401 starting at the edge of the ROM Board 100 extending about 2/6 of the length of the ROM Board 100, a second portion 402 that extends from the end of the first portion 401 for about ⅙ of the length of the ROM Board 100 and includes chair stops 102 that extend laterally from the ROM Board 100, a third portion 403 that extends from the end of the second portion 402 about ⅙ of the length of the ROM Board 100 and comprises a flat planar surface 103 and a fourth portion 404 extending from the end of the third portion about ⅓ of the length of the ROM Board 100 to the terminal end of the ROM Board 100 there being a plurality of undulating elevated foot stops 104 on the fourth portion 404 thereof, such undulating elevated foot stops 104 becoming progressively taller from the proximate end to the terminal end of the fourth portion. In one embodiment of the ROM Board 100 there are 3 lateral indents or indentations 101 and 3 undulating elevated foot stops 104.

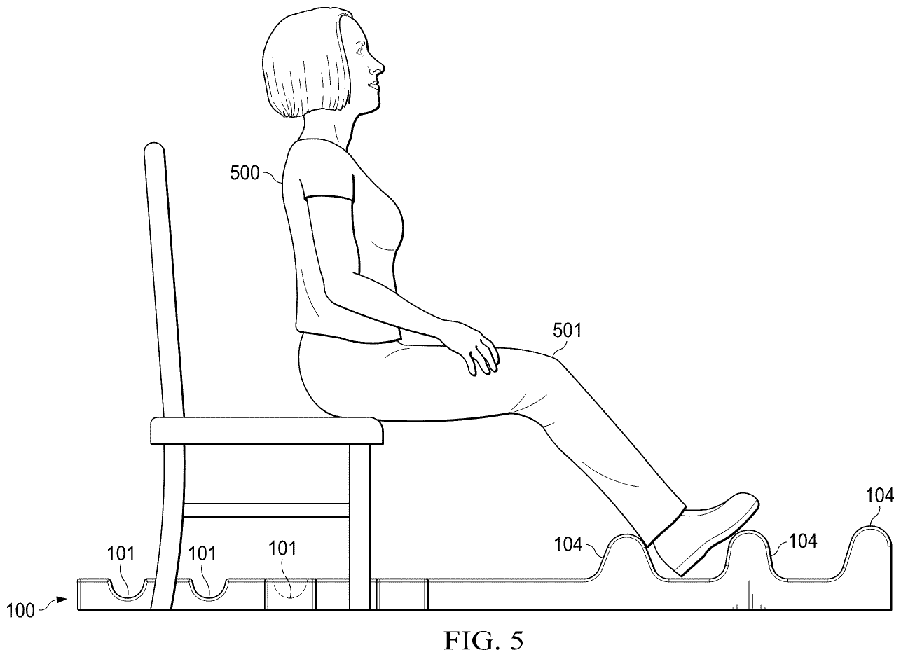

Referring to FIG. 5, there is a view of a patient 500 using the ROM Board 100 invention showing a positioning of the knee 501 at a 45-degree angle of flexion.

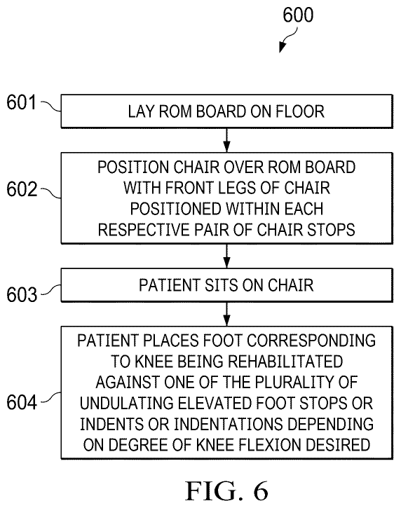

Referring now to FIG. 6, the method 600 of the invention overcomes the disadvantage of the limited time available to the post-operative TKA patient doing physical therapy. In the method 600, the ROM Board is laid on the floor 601. A chair is then positioned within the front legs of the chair positioned within each respective pair of the chair stops 602. The patient then sits in the chair 603. The patient then places their foot corresponding to the knee being rehabilitated against one of the plurality of undulating elevated foot stops or indents or indentations depending on the degree of knee flexion desired 604. In an embodiment of the method, the patient places their foot or ankle atop the most terminal stop in full extensions and then progressively moves their foot from the most terminal foot stop to the most terminal indent or indentation and from the most terminal indent or indentation to the most terminal undulating elevated foot stop repeatedly in order to move the knee from approximately 0 degrees of flexion to 180 degrees of flexion and back.

The invention addresses a post-operative TKA patient's limited time doing physical therapy. Typically, the patient receives 2-3 sessions of 30 minutes to an hour of physical therapy per week after a knee replacement. The time between those sessions may or not be used by a patient to help regain their knee range of motion. A major post-operative complication from a knee replacement is a stiff knee. A lack of proper therapy can be a cause of a stiff knee. The invention provides an apparatus to patients to work on their knee range of motion and therapy when they are not working with their physical therapist. The invention will increase the time a patient is working on their knee range of motion and will decrease the prevalence of post-operative stiffness. The invention allows a patient to do self-guided home therapy.

The invention is a ROM Board placed on the ground or floor under a chair. The ROM Board is able to lock into the chair to keep it secured while the patient is using the invention. The invention, in an embodiment is fabricated of hard plastic with undulating elevated foot stops to allow patient to progressively flex the knee from extended position from 0 degrees extension to 90 degrees of flexion. The ROM Board also has progressive indents for foot locking as the patient flexes under the chair from 90 degrees to past 120 degrees of flexion.

Advantages of the invention include it being a single solid device manufactured from a single mold having an undulating elevated surface that is progressively decreased in height so as to allow the patient to extend their leg on the furthest peak of the board to help their extension, the peaks being separated to allow progressive flexion of the knee; the peaks being from 0 -90 degrees to lock the heal and plantar foot on the board and then indents from 90 degrees and up to lock the toes in the board. Further, the invention is lightweight and easy to transport from orthopaedic clinic to home. It is made of a hollow plastic to allow the invention to be easily stackable for storage at an orthopaedic or physical therapy business. The invention is plastic and easily cleaned, overcoming concerns for infections in post-operative TKA patients. The invention facilitates the patient being able to increase the time that they undergo therapy work post-operative and thus improving their range of motion and ultimate post-operative outcome.

The invention is directed to orthopaedic post-operative patients, specifically total knee replacement patients. The invention could also be used for post-operative sports medicine patients after surgery or other orthopaedic distal femur, proximal tibia, knee procedures. The invention is a plastic board facilitating range of motion exercise using progressive knee flexion. The invention could also be used with patients who have had recent hip procedures.

The invention is an apparatus to assist in range of motion (ROM) exercises, comprising a ROM board configured to lay on the ground or floor, the board dimensioned to receive a chair, the board has a plurality of undulating elevated foot stops of varying heights. The ROM board has generally a rectangular shape with a pair of lateral chair stop extensions extending from each side of the ROM board.

The ROM board has a first portion starting from a first end of the ROM board the first portion being a planar surface with a plurality of lateral indents or indentations, a second portion that extends from the end of the first portion for about that includes the pair of lateral chair stop extensions that extend out laterally from each side of the ROM board, a third portion that extends from the end of the second portion and comprises a flat planar surface and a fourth portion extending from the end of the third portion to a terminal end of the ROM board and having thereon the plurality of undulating elevated foot stops.

The plurality of undulating elevated foot stops become progressively taller from the proximate end to the terminal end of the fourth portion, said undulating elevated foot stops run laterally across the surface of the ROM board. The idents or indentations have a concavity with a radius and the undulating elevated foot stops comprise a convex structure having a radius. The first portion commences at an edge of the ROM board extending about 2/6 of the length of the ROM board, the second portion extends from the end of the first portion for about ⅙ of the length of the ROM board and includes a pair of chair stops that extend out laterally from each side of the ROM board, the third portion extends from the end of the second portion about ⅙ of the length of the ROM board and comprises a flat planar surface and the fourth portion extends from the end of the third portion about ⅓ of the length of the ROM board to the terminal end of the ROM board.

The plurality of undulating elevated foot stops are integrated on the fourth portion of the ROM board, such undulating elevated foot stops becoming progressively taller from the proximate end to the terminal end of the fourth portion and running laterally across the surface of the ROM board. In an embodiment, the ROM board has 3 lateral indents or indentations and 3 undulating elevated foot stops.

In an embodiment, the ROM Board can have an overall length of between 30 inches and 60 inches and width of between 10 inches and 30 inches, with each portion being a subset of such overall length but having the same width. In an embodiment, the depth of each indent or indentation 101 at the extent thereof is between 0.25 inches and 3 inches and the height of each undulating elevated foot stop 104 is between 1 inch and 7 inches.

The invention is the ROM board in combination with a chair. In an embodiment, the ROM board is fabricated as an integrated plastic structure. In an embodiment, the ROM board is comprised of a plurality of components that are integrated together to form the ROM board. In an embodiment, the undulating elevated foot stops become progressively taller toward a terminal end of the ROM board and extend laterally across the surface of the ROM board. In an embodiment, the ROM Board is dimensioned to receive a chair within a pair of lateral chair stop extensions which extend from each side of the ROM Board. In an embodiment, the ROM Board is fabricated from plastic in an injection molding process or similar process.

The invention further comprises a method of rehabilitating a knee, comprising the steps of placing a ROM board on the floor; positioning front legs of a chair within a respective pair of the chair stops of the ROM Board; sitting a patient in the chair; and placing by the patient their leg corresponding to the knee being rehabilitated from full extension atop the most terminal foot stop to moving their foot against one of a plurality of undulating elevated foot stops or indents or indentations depending on the degree of knee flexion desired.

In an embodiment of the method, the patient progressively moves their leg from full extension atop the most terminal foot stop to moving their foot from the most terminal foot stop to the most terminal indent or indentation and from the most terminal indent or indentation to the most terminal undulating elevated foot stop repeatedly in order to move the knee from approximately 0 degrees of flexion to about 120 degrees of flexion and back.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the disclosed invention and the system that implements the invention without departing in any way from the spirit and scope of the invention

What i claim is:

1. An apparatus to assist in range of motion (ROM) exercises, comprising a ROM board configured to lay on the ground or floor, the ROM board dimensioned to receive one or more legs of a chair, the ROM board having a plurality of undulating elevated foot stops of varying heights.

2. The apparatus of claim 1, wherein the ROM board has generally a rectangular shape with a pair of lateral chair stop extensions extending from each side of the ROM board.

3. The apparatus of claim 2, further comprising a plurality of lateral indents or indentations, and wherein ROM board has a first portion starting from a back edge of the ROM board, the first portion being a planar surface with the plurality of lateral indents or indentations, a second portion that extends from the first portion that includes the pair of lateral chair stop extensions which extend out laterally from each side of the ROM board, a third portion that extends from the second portion and comprises a flat planar surface and a fourth portion extending from the third portion to a terminal end of the ROM board and having thereon the plurality of undulating elevated foot stops.

4. The apparatus of claim 3, wherein the plurality of undulating elevated foot stops become progressively taller from the proximate end to the terminal end of the fourth portion, said undulating elevated foot stops run laterally across the surface of the ROM board.

5. The apparatus of claim 4, wherein the idents or indentations have a concavity with a radius and the undulating elevated foot stops comprise a convex structure having a radius and wherein the ROM board has an overall length of between 30 inches and 60 inches and width of between 10 inches and 30 inches, with each portion being a subset of such overall length but having the same width and the depth of each indent or indentation 101 is between 0.25 inches and 3 inches and the height of each undulating elevated foot stop 104 is between 1 inch and 7 inches.

6. The apparatus of claim 3, wherein the first portion commences at an edge of the ROM board extending about 2/6 of the length of the ROM board, the second portion extends from the end of the first portion for about ⅙ of the length of the ROM board and includes a pair of chair stops that extend out laterally from each side of the ROM board, the third portion extends from the end of the second portion about ⅙ of the length of the ROM board and comprises a flat planar surface and the fourth portion extends from the end of the third portion about ⅓ of the length of the ROM board to the terminal end of the ROM board.

7. The apparatus of claim 6, wherein the plurality of undulating elevated foot stops are integrated on the fourth portion of the ROM board, such undulating elevated foot stops becoming progressively taller from the proximate end to the terminal end of the fourth portion and running laterally across the surface of the ROM board.

8. The apparatus of claim 7, where the ROM board have 3 lateral indents or indentations and 3 undulating elevated foot stops.

9. The apparatus of claim 8, wherein the ROM board has an overall length of between 30 inches and 60 inches and width of between 10 inches and 30 inches.

10. The apparatus of claim 8, wherein the depth of each indent or indentation at the extent thereof is between . 25 inches and 3 inches and the height of each undulating elevated foot stop is between 1 inch and 7 inches.

11. The apparatus of claim 8 in combination with a chair.

12. The apparatus of claim 8, the ROM board being fabricated as an integrated plastic structure.

13. The apparatus of claim 8, wherein the ROM board is comprised of a plurality of components integrated together to form the ROM board.

14. The apparatus of claim 1, wherein the undulating elevated foot stops become progressively taller toward a terminal end of the ROM board and extend laterally across the surface of the ROM board.

15. The apparatus of claim 1, wherein the height of each undulating elevated foot stop is between 1 inch and 7 inches.

16. The apparatus of claim 1, wherein the ROM board is dimensioned to receive at least two legs of a chair within a pair of lateral chair stop extensions which extend from each side of the ROM board.

17. The apparatus of claim 1, wherein the ROM board is fabricated from plastic in an injection molding process or similar process.

18. A method of rehabilitating a knee, comprising the steps of:
laying a ROM board on the floor;
positioning front legs of a chair within a respective pair of the chair stops of the ROM Board;
sitting a patient in the chair;
placing by the patient their leg corresponding to the knee being rehabilitated from full extension atop the most terminal foot stop to moving their foot against one of a plurality of undulating elevated foot stops or indents or indentations depending on the degree of knee flexion desired.

19. The method of claim 18, wherein the ROM board comprises a first portion commencing from a first end of the ROM board, the first portion being a planar surface with a plurality of lateral indents or indentations, a second portion that extends from the first portion for that includes a pair of lateral chair stop extensions that extend out laterally from each side of the ROM board, a third portion that extends from the second portion and comprises a flat planar surface and a fourth portion extending from the third portion to a terminal end of the ROM board and having thereon the plurality of undulating elevated foot stops.

20. The method of claim 19, wherein the patient progressively moves their leg from full extension atop the most terminal foot stop to moving their foot from the most terminal foot stop to the most terminal indent or indentation and from the most terminal indent or indentation to the most terminal undulating elevated foot stop repeatedly in order to move the knee from approximately 0 degrees of flexion to about 120 degrees of flexion and back.
